(19) United States
(12) Patent Application Publication
(10) Pub. No.: US 2026/0309846 A1
(43) Pub. Date: Oct. 8, 2026

(54) POROUS ANTIREFLECTIVE COATING FOR A NEAR-INFRARED SENSOR COVER

(71) Applicant: AGC GLASS EUROPE, Louvain-la-Neuve (BE)

(72) Inventors: Xavier LALOYAUX, Gosselies (BE); Jiangping WANG, Gosselies (BE); Grégory ARNOULT, Gosselies (BE); Samuel MACHI, Gosselies (BE); Gerard RUITENBERG, Gosselies (BE)

(73) Assignee: AGC GLASS EUROPE, Louvain-la-Neuve (BE)

(21) Appl. No.: 19/481,628

(22) PCT Filed: May 28, 2024
(86) PCT No.: PCT/EP2024/064638

§ 371 Date: Nov. 5, 2025

(30) Foreign Application Priority Data
May 31, 2023 (EP) 23176457

(51) Int. Cl. G01S 7/481; G01S 17/931

(52) U.S. Cl. CPC G01S 7/4813; G01S 17/931

(57) ABSTRACT

A glass cover for a near-infrared sensor operating in the wavelength range from 850 nm to 1550 nm. The glass cover has an internal face facing the near-infrared sensor and an external face opposite to the internal face. The glass cover includes at least a first glass sheet and a porous antireflective coating. The antireflective coating is deposited on the internal face and/or on the external face of the glass cover. The porous antireflective coating presents a mean refractive index from 1.32 to 1.42 operating in the wavelength range from 850 nm to 1550 nm. The antireflective coating presents further an optical thickness (in nm) having a minimal value of:

$$0.208 λ + 2 nm$$

and a maximal value of:

$$0.303 λ + 11 nm$$

where λ is the operating wavelength (in nm) of the near-infrared sensor.

### FIELD OF THE INVENTION

The present invention relates to the field of antireflective coatings. More specifically it relates to an antireflective coating for a cover of a near-infrared sensor.

### BACKGROUND OF THE INVENTION

Nowadays vehicles are equipped with increasing number of optical sensors, in particular having operating wavelength in the near-infrared wavelength range, meaning from 850 to 1550 nm. Vehicles include cars, vans, lorries, motorbikes, busses, trams, trains, drones, airplanes, helicopters and the like.

WO2018015312A1 concerns an automotive glazing comprising (i) at least one glass sheet having an absorption coefficient lower than 5 m⁻¹ in the wavelength range from 750 to 1050 nm and having an external face and an internal face, and (ii) an infrared blocking filter. An infrared-based remote sensing device in the wavelength range from 750 to 1050 nm, is placed on the internal face of the glass sheet in a zone free of the infrared blocking filter layer, the windshield thus forming a cover for the infrared sensing device. Such device has indeed to be protected from the external environment behind a cover, as it is not resistant to said external environment.

Covers for near-infrared sensors, such as an infrared camera or a lidar, are particularly used in the automotive field. The near-infrared sensor is typically placed behind a cover to protect the sensor from the external environment. The detection limit of the near-infrared sensor is evidently linked to the transmission level of the cover at the operating wavelength of the sensor.

It is therefore needed to increase the transmission level of said cover in the near-infrared wavelength range. Such increase in transmission may typically be achieved with antireflective coatings comprising alternating layers of low refractive index material and high refractive index material, which will thus reduce the reflection of the incident light on the surface of the cover. Such interferential coatings may typically improve the efficiency of the cover by increasing the transmission of the near-infrared light through said coated cover. Interferential coatings, as disclosed for example in CN110218006B, provide reflectance reduction over a narrow wavelength range and is thus not useful in various applications.

Further, interferential coatings, although effective to reduce the near-infrared reflectance, are not efficient with mainly p-polarized light at incident angle comprised between 45° to 80°. As the incident light from a near-infrared sensor, such as a lidar, can be mixed or mainly p-polarized, the efficiency of the coating for both unpolarized and p-polarized incident light is important. Besides, due to its interaction with the external environment, the reflected beam undergoes depolarization for p-polarized light and mainly unpolarized light returns to the infrared sensor. It is therefore important for the coating to be efficient for both unpolarized light and mainly p-polarized light.

Moreover interferential coatings are commonly applied through physical vapor deposition (PVD). It therefore needs to be applied under specific pressure and temperature. Besides, using PVD process, it means that if a zone does not need to be coated, such zone must be masked during the process. It therefore leads to waste of the coated material.

The durability of antireflective coatings has so far not been sufficient to maintain the optical performance during the lifetime of the product. Further, the colors in reflection in the visible range (with wavelengths from 350 to 780 nm) are not necessarily optimized. In particular, it is difficult to obtain antireflective coatings for near-infrared radiation, in the range between 850 and 1550 nm, while maintaining low visible light reflectance and/or reflected light colors that are close to neutral. The antireflective coating is optimized in the near-infrared wavelength range, but its impact on the perceived color of the antireflective coating has to be taken into account.

CN114290770 mentions an antireflective coating made through ionic implantation. The first surface of the outer glass plate is implanted with ions to form a first ion implantation layer. However, such coating is not thermally stable, and is usually not efficient after heat treatment.

There thus remains a need for an efficient antireflective coating in the near-infrared wavelength range, with improved chemical and mechanical durability, which could be used for both unpolarized and mainly p-polarized light and can be locally deposited where the function is required.

### SUMMARY OF THE INVENTION

The present invention concerns a glass cover for a near-infrared sensor operating in the wavelength range from 850 nm to 1550 nm. The glass cover has an internal face facing the near-infrared sensor and an external face opposite to the internal face. The glass cover comprises at least a first glass sheet. The glass cover further comprises a porous antireflective coating. The antireflective coating is deposited on the internal face and/or on the external face of the glass cover. The porous antireflective coating presents a mean refractive index comprised between 1.32 and 1.42 in the wavelength range from 850 nm to 1550 nm. The antireflective coating presents further an optical thickness (in nm) comprised between a minimal value of:

$$0.208 λ + 2 nm$$

and a maximal value of:

$$0.303 λ + 11 nm$$

where λ is the operating wavelength of the near-infrared sensor.

The present invention further concerns a system comprising a glass cover according to the present invention and a lidar.

The present invention further concerns a vehicle comprising a system according to the present invention.

### DETAILED DESCRIPTION OF ILLUSTRATIVE EMBODIMENTS

The present invention will be described with respect to particular embodiments but the invention is not limited thereto.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a glass cover for a near-infrared sensor operating in the wavelength range from 850 nm to 1550 nm. The cover is understood as an optical element positioned in front of the near-infrared sensor. The cover can be the window of a physical aperture in the housing of the near-infrared sensor. The cover can also be provided in front of the housing of the near-infrared sensor, wherein the near-infrared sensor already comprises a window closing the aperture of the housing. The internal face of the cover faces the near-infrared sensor, while the external face is opposite to the internal face.

A near-infrared sensor is a sensor whose operating wavelength is situated in the near-infrared wavelength range, meaning between 850 nm and 1550 nm. A near-infrared sensor may refer to a system that only detects near-infrared light, or to a system that both emits and detects near-infrared light. It encompasses near-infrared detectors and lidar (also written ladar or named laser radar). Lidar is an acronym for “light detection and ranging”. It is sometimes called “laser scanning” or “3D scanning”. The technology uses laser beams to create a 3D-representation of the surveyed environment. Operating wavelength of lidar compatible with the present invention is comprised between 850 nm and 1550 nm (usually referred to as near-infrared). More specifically, known operating wavelengths of currently produced lidars compatible with the present invention are 850 nm, 905 nm, 940 nm, 1064 nm, 1310 nm, 1350 nm, 1550 nm. An acceptable variance of 25 nm around the nominal value of the operating wavelength may be considered, such that, for example, a wavelength range of 1525 nm to 1575 nm may be accepted around the nominal value of 1550 nm.

The cover of the present invention comprises at least a first glass sheet. The glass sheet has a composition that is not particularly limited. The glass sheet may be a soda-lime-silicate glass, an alumino-silicate glass, an alkali-free glass, a boro-silicate glass, . . . . Preferably, the glass sheet of the invention is made of a soda-lime glass or an alumino-silicate glass. The glass sheet according to the invention may be a glass sheet obtained by a floating process, a drawing process, a rolling process or any other process known to manufacture a glass sheet starting from a molten glass composition. According to a preferred embodiment according to the invention, the glass sheet is a float glass sheet. The term “float glass sheet” is understood to mean a glass sheet formed by the float glass process, which consists in pouring the molten glass onto a bath of molten tin, under reducing conditions. The glass sheet preferably has a thickness comprised between 0.5 mm and 6 mm, more preferably between 1 mm and 4 mm. Usual thickness for such glass sheet is 1.6 mm, 2.1 mm, 3.1 mm or 4 mm.

The cover of the present invention further comprises a porous antireflective coating. Such porous antireflective coating can be made by sol-gel process or under atmospheric plasma. The porous antireflective coating may be deposited on at least part of the internal face and/or on the external face of the cover. Deposition on the internal face allows for better resistance to external environment as the coating is not exposed to external environment. However, deposition on the external face is also possible. The porous antireflective coating presents a mean (over the thickness of the coating) refractive index comprised between 1.32 and 1.42 in the wavelength range from 850 nm to 1550 nm. Such mean refractive index is obtained through parameters linked to the process to obtain the porous antireflective coating which are well known by the skilled in the art.

For atmospheric plasma chemical vapour deposition (APCVD) like plasma jet chemical vapour deposition, the precursors composition and flow rate can be adjusted to design the porosity of an anti-reflective coating. For example, the porosity of the layer can be designed by the amount of carbon contained in the precursor. In contrast to plasma enhanced chemical vapour deposition (PECVD), the APCVD allows to obtain a directional film deposition which effectively reduces the parasitic coating of the walls. Hence, frequent time-consuming and expensive reactor cleaning steps are avoided. Furthermore, this atmospheric process allows also to deposit locally a coating without any constraints on the glass dimension. In vacuum technology, for partial coated substrate the full substrate required to be in the chamber. Because of these advantages, the APCVD process is particularly attractive for the local and cost-effective fabrication of antireflective coatings.

For sol-gel, the design of the porosity is linked for example to molar ratio of solvent compared to silicon precursor or the molar ratio of water compared to silicon precursor during sol-gel processing.

The porous antireflective coating is optimized in the wavelength range from 850 nm to 1550 nm. It means that the transmission increase obtained by depositing the porous antireflective coating, on a substrate, measured, in particular at normal incidence, in the wavelength range from 850 nm to 1550 nm is higher than in the visible wavelength range (350 nm to 780 nm). As known by the skilled in the art, the intrinsic transmission of a coating cannot be measured directly. The coating must be applied on a substrate, and it is the transmission of this coating on the substrate that is measured. By comparing the transmission of the coating deposited on the substrate and the transmission of the substrate alone, the gain in transmission thanks to the coating can be calculated.

The antireflective coating presents an optical thickness (in nm) comprised between a minimal value of:

$$0.208 λ + 2 nm$$

and a maximal value of:

$$0.303 λ + 11 nm$$

where λ is the operating wavelength (in nm) of the near-infrared sensor. Such optical thickness represents an efficient compromise between optical gain and mechanical resistance.

With an optical thickness comprised between the aforementioned values, in particular for unpolarized light, the gain in transmission of the coated glass cover compared to the uncoated glass is advantageously superior or equal to 1.3% at the operating wavelength of the near-infrared sensor, for an incident angle comprised between 0° and 65°. Such gain represents therefore an increase of the light sent/received by the near-infrared sensor. Such an increase is particularly interesting, as it leads to higher efficiency of the near-infrared sensor.

Moreover, for p-polarized (100% p-polarized) light (according to the incident plane formed by the normal vector of the glass cover and the vector of the incident beam), the transmission loss, measured at the Brewster angle (57°), of the coated glass cover is less than 2%. The measure at the Brewster angle allows to get rid of the reflection due to the glass itself, and to get the contribution of the coating only. Such porous antireflective coating is therefore particularly interesting in case of mainly p-polarized light, for example in case of mainly p-polarized light sent by a near-infrared sensor emitting mainly p-polarized light according to the incident plane formed by the normal vector of the glass cover and the vector of the incident beam. This is particularly interesting while comparing with interferential coatings, typically comprising an alternance of high and low refractive index, which exhibit a transmission loss usually above 2% with 100% p-polarized light.

In a preferred embodiment, the antireflective coating is based on a mineral composition able to support 500° C., more preferably 600° C., without changes of optical properties, meaning the gain in transmission and the transmission loss described previously do not vary significantly. In particular, difference in gain in transmission and/or transmission loss, due to heat treatment at a temperature of at least 500° C., or even at least 600° C., for a duration of at least 5 minutes may be less than 1%, less than 0.5% or even less than 0.2%. Such heating may be necessary in case of hot bending (glass forming) of the glass cover.

In a preferred embodiment, the antireflective coating resists to an internal environment like the interior of a vehicle. The coating can face directly the interior environment and sustains wear including touch, abrasion or scratch from a user. Mechanical durability in the scope of the present invention includes the test methods of the Automatic Wet Rub test, and the Dry Brush Test, before and after a thermal treatment.

For the automatic Wet Rub Test (AWRT), a piston covered with a wet cotton cloth that is kept wet is brought into contact with the layer to be evaluated and moved back and forth over its surface. The piston bears a weight so as to apply a force of 33N to a finger having a diameter of 17 mm. The rubbing of the cotton over the coated surface damages (removes) the layer after a certain number of cycles. The test is used to define the limit at which the layer discolors (partial removal of the layer) and scratches appear therein. The test is carried out for 10, 50, 100, 250, 500 and 1000 cycles in various separate locations on the sample. The sample is observed under an artificial sky in order to determine whether discoloration or scratching of the sample is visible in reflection. The results for each test described above are obtained by visually assessing samples in comparison with a defined scale of reference samples. Scales are based on an internal scale from 0 to 10, with 0 corresponding to a standard sample having critical deterioration. The value of 10 corresponds to a perfect or substantially perfect surface, free of any deterioration sign. The intermediate values (down to the 0.25 unit), correspond to samples of the internal scale having different levels of deterioration, ranked in order of level of deteriorations. Acceptable values are from 6 to 10.

The dry brush test (DBT) is run according to standard ASTM D2486-00 (test method “A”), alternatively for at least 250 cycles, alternatively for at least 500 cycles, or alternatively 1000 cycles. This test may also be carried out on samples after they have been subjected to heat treatment (described above, here referred to as “bake”). The results of DBT are evaluated as for AWRT.

In a preferred embodiment, the near-infrared sensor is a lidar. Preferably, the lidar is configured to emit a linearly polarized beam, more preferably a mainly p-polarized beam in the incident plane formed by the normal vector of the glass cover and the vector of the incident beam of the lidar.

In a preferred embodiment, the glass cover further comprises a second glass sheet and an interlayer laminating the first glass sheet and the second glass sheet. The interlayer is usually made of polyvinyl butyral (PVB), polyurethane (PU) or ethylene-vinyl acetate (EVA).

In a preferred embodiment, the at least first glass sheet and/or the second glass sheet has an absorption coefficient less than 15 m⁻¹ at the operating wavelength of the near-infrared sensor, more preferably less than 10 m⁻¹, even more preferably less than 5 m⁻¹.

To quantify the low absorption of the glass sheet in the near-infrared range, in the present description, the absorption coefficient is used in the wavelength range from 850 nm to 1550 nm. The absorption coefficient is defined by the ratio between the absorbance and the optical path length traversed by electromagnetic radiation in a given environment. It is expressed in m⁻¹. It is therefore independent of the thickness of the material but it is function of the wavelength of the absorbed radiation and the chemical nature of the material.

In the case of glass, the absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

$$with ρ = {( n - 1 )}^{2} / {( n + 1 )}^{2} .$$

According to the present invention, the glass sheet having an absorption coefficient at the operating wavelength of the near-infrared sensor of less than 15 m⁻¹, preferably less than 10 m⁻¹, even more preferably less than 5 m⁻¹, may be a soda-lime-silica glass, alumino-silicate, boro-silicate, . . . .

Preferably, a glass composition compatible with the present invention comprises a total content expressed in weight percentages of glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

More preferably, a glass composition compatible with the present invention comprises in a content expressed as total weight of glass percentages:

| | |
|---|---|
| SiO₂ | 55-78% |
| Al₂O₃ | 0-18% |
| B₂O₃ | 0-18% |
| Na₂O | 0-20% |
| CaO | 0-15% |
| MgO | 0-10% |
| K₂O | 0-10% |
| BaO | 0-5% |

More preferably, for reasons of lower production costs, the glass compatible with the present invention is made of soda-lime glass. A glass composition compatible with the present invention comprises a content expressed as the total weight of glass percentages:

| | |
|---|---|
| SiO₂ | 60-75% |
| Al₂O₃ | 0-6% |
| B₂O₃ | 0-4% |
| CaO | 0-15% |
| MgO | 0-10% |
| Na₂O | 5-20% |
| K₂O | 0-10% |
| BaO | 0-5%. |

In addition to its basic composition, the glass may include other components, nature and adapted according to quantity of the desired effect. A solution to obtain a very transparent glass in the near-infrared, with weak or no impact on its aesthetic or its color, is to combine in the glass composition a low iron quantity and optionally chromium in a range of specific contents. Thus, the glass preferably has a composition which comprises a content expressed as the total weight of glass percentages:

$$\begin{matrix}Fe total ( expressed as {Fe}_{2} {O}_{3} ) & 0.002 - 0.06 \% \\ {Cr}_{2} {O}_{3} & 0 - 0.06 \% .\end{matrix}$$

Such glass compositions combining low levels of iron and chromium showed particularly good performance in terms of near-infrared reflection and show a high transparency in the visible and a little marked tint, near a glass called “extra-clear”. These compositions are described in international applications WO2014128016A1, WO2014180679A1, WO2015011040A1, WO2015011041A1, WO2015011042A1, WO2015011043A1 and WO2015011044A1.

According to a preferred embodiment, the glass cover is a part of a windshield, a backlite (window at the back of a vehicle), a sidelite (a sidelite is understood as a window placed on the left or the right of a vehicle) or an exterior trim element of a vehicle. An exterior trim element includes bumper, window/door seal, pillar, wheel well, wheel arch, fender, headlight, mirror body and roof cover. Such exterior trim element can also be deployable, meaning it can pop out from the vehicle only when needed. Vehicle manufacturers use these exterior trim elements to add aesthetics, increase function, and add flexibility to the vehicle design.

The present invention further proposes a system comprising a glass cover as described previously and a lidar.

In a preferred embodiment, the lidar emits mainly p-polarized (meaning at least 60% of the light is p-polarized, preferably 70%, more preferably 80%, even more preferably 90%, the most preferred 100%) light according to the incident plane formed by the normal vector of the glass cover and the vector of the incident beam of the lidar.

In a preferred embodiment, the angle of incidence of the beam from the lidar on the glass cover is comprised between 0° and 65°, more preferably between 45° and 65° (measured from the normal to the glass cover).

In a preferred embodiment, the lidar operates at 905 nm or at 1550 nm.

The present invention further proposes a vehicle comprising a system as previously described.

The following Table 1 illustrates several examples of porous antireflective coatings, with a mean refractive index at a wavelength of 905 nm comprised between 1.32 and 1.42. The coatings are deposited on an extra-clear 1.6 mm thick glass substrate with a refractive index of 1.51 at a wavelength of 905 nm. As known by the skilled in the art, the optical thickness (in nm) is obtained by multiplying the mean refractive index by the thickness of the coating. The minimal and maximal optical thicknesses are calculated based on the formulae given previously, where λ=905 nm.

TABLE 1

| | | | | Minimal | Maximal |
|---|---|---|---|---|---|
| | Mean | | Optical | optical | optical |
| | refractive | Thickness | thickness | thickness | thickness |
| Reference | index | (nm) | (nm) | (nm) | (nm) |
| Coating 1 | 1.32 | 160 | 211.2 | 190.2 | 285.2 |
| Coating 2 | 1.39 | 142 | 197.4 | 190.2 | 285.2 |
| Coating 3 | 1.42 | 134 | 190.3 | 190.2 | 285.2 |
| Coating I | 1.32 | 364 | 480 | 190.2 | 285.2 |
| Coating II | 1.39 | 91.6 | 127.3 | 190.2 | 285.2 |
| Coating III | 1.42 | 88.5 | 125.7 | 190.2 | 285.2 |

As can be seen, the optical thickness of the coatings 1, 2 and 3 are comprised within the minimal and maximal values defined in the present invention, while the coating I, II and III are out of the defined range.

The following Table 2 illustrates the transmission at 905 nm of the naked glass and the coated glass, measured at Brewster angle, for unpolarized light. The gain in transmission is also given.

TABLE 2

| | Transmission | Transmission | |
|---|---|---|---|
| | of naked | of coated | Gain |
| Reference | glass (%) | glass (%) | (%) |
| Coating 1 | 86.47 | 89.64 | 3.17 |
| Coating 2 | 86.47 | 88.53 | 2.06 |
| Coating 3 | 86.47 | 87.99 | 1.52 |
| Coating I | 86.47 | 87.50 | 1.03 |
| Coating II | 86.47 | 87.54 | 1.07 |
| Coating III | 86.47 | 87.30 | 0.83 |

The gain is indeed above 1.3% for the coatings within the mean refractive index range given, as well as within the optical thickness range given. Such increase in transmission is particularly interesting for near-infrared sensor efficiency, as it increases the signal transmission sent by the near-infrared sensor.

The following Table 3 illustrates the transmission, at 905 nm, measured at Brewster angle (57°), for p-polarized light (100% p-polarized light) according to the incident plane formed by the normal vector of the glass cover and the vector of the incident beam, of the same coated glass covers 1, 2 and 3 compared to uncoated glass. For comparison, the transmission is also given for an interferential coating made of 8 layers alternating high refractive index (2.3) and low refractive index (1.5) (thickness of the layers, starting from high index layer which is firstly deposited on glass: 13.5 nm, 45.8 nm, 37.9 nm, 26.6 nm, 36.5 nm, 43.9 nm, 9.6 nm, 99.7 nm).

TABLE 3

| | Transmission | Transmission | |
|---|---|---|---|
| | of naked | of coated | Loss |
| Reference | glass (%) | glass (%) | (%) |
| Coating 1 | 99.96 | 99.61 | 0.35 |
| Coating 2 | 99.96 | 99.79 | 0.17 |
| Coating 3 | 99.96 | 99.86 | 0.10 |
| Interf 905 nm | 99.96 | 96.30 | 3.66 |

The loss is indeed below 2% for the coatings within the mean refractive index range given, as well as within the optical thickness range given. Compared to the interferential coating (which exhibits a loss of 3.66%), the loss in transmission is very low, meaning the coating has nearly no impact on the transmission of p-polarized light. It is particularly interesting for a near-infrared sensor emitting mainly p-polarized light according to the incident plane formed by the normal vector of the glass cover and the vector of the incident beam.

The following Table 4 illustrates several examples of porous antireflective coatings, with mean refractive index comprised between 1.32 and 1.42, the coating being deposited on an extra-clear 1.6 mm thick glass with a refractive index of 1.50 at 1550 nm. As known by the skilled in the art, the optical thickness (in nm) is obtained by multiplying the mean refractive index by the thickness of the coating. The minimal and maximal optical thicknesses are calculated based on the formulae given previously, where λ=1550 nm.

TABLE 4

| | | | | Minimal | Maximal |
|---|---|---|---|---|---|
| | Mean | | Optical | optical | optical |
| | refractive | Thickness | thickness | thickness | thickness |
| Reference | index | (nm) | (nm) | (nm) | (nm) |
| Coating 4 | 1.32 | 356 | 469.9 | 324.4 | 480.7 |
| Coating 5 | 1.39 | 336 | 467.0 | 324.4 | 480.7 |
| Coating 6 | 1.42 | 338 | 480.0 | 324.4 | 480.7 |
| Coating A | 1.32 | 140 | 184.8 | 324.4 | 480.7 |
| Coating B | 1.39 | 127 | 176.5 | 324.4 | 480.7 |
| Coating C | 1.42 | 116 | 164.7 | 324.4 | 480.7 |

As can be seen, the optical thickness of the coatings 4, 5 and 6 are comprised within the minimal and maximal values defined in the present invention, while the coating A and B are out of the defined range.

The following Table 5 illustrates the transmission at 1550 nm of the naked glass and the coated glass, at Brewster angle, for unpolarized light. The gain in transmission is also given.

TABLE 5

| | Transmission | Transmission | |
|---|---|---|---|
| | of naked | of coated | Gain |
| Reference | glass (%) | glass (%) | (%) |
| Coating 4 | 86.51 | 90.30 | 3.79 |
| Coating 5 | 86.51 | 89.02 | 2.51 |
| Coating 6 | 86.51 | 88.40 | 1.89 |
| Coating A | 86.51 | 87.57 | 1.06 |
| Coating B | 86.51 | 87.21 | 0.70 |
| Coating C | 86.51 | 86.98 | 0.47 |

The gain is indeed above 1.3% for the coatings within the mean refractive index range given, as well as within the optical thickness range given. Such increase in transmission is particularly interesting for near-infrared sensor efficiency, as it increases the signal transmission sent by the near-infrared sensor.

The following Table 6 illustrates the transmission, at 1550 nm, measured at Brewster angle (57°), for p-polarized light (100% p-polarized light) according to the incident plane formed by the normal vector of the glass cover and the vector of the incident beam, of the same coated glass covers 4, 5 and 6 compared to un coated glass. For comparison, the transmission is also given for an interferential coating made of made of 4 layers alternating high refractive index (2.3) and low refractive index (1.5) (thickness of the layers, starting from high index layer which is firstly deposited on glass: 65.0 nm, 67.0 nm, 234.2 nm, 240.0 nm).

TABLE 6

| | Transmission | Transmission | |
|---|---|---|---|
| | of naked | of coated | Loss |
| Reference | glass (%) | glass (%) | (%) |
| Coating 4 | 99.80 | 99.40 | 0.40 |
| Coating 5 | 99.80 | 99.60 | 0.20 |
| Coating 6 | 99.80 | 99.68 | 0.12 |
| Interf 1550 nm | 99.80 | 97.38 | 2.42 |

The loss is indeed below 2% for the coatings within the mean refractive index range given, as well as within the optical thickness range given. Compared to the interferential coating (which exhibits a loss of 2.42%), the loss in transmission is very low, meaning the coating has nearly no impact on the transmission of p-polarized light. It is particularly interesting for a near-infrared sensor emitting mainly p-polarized light according to the incident plane formed by the normal vector of the glass cover and the vector of the incident beam.

The coatings of the present invention are thus efficient for both unpolarized light and p-polarized light.

While the invention has been illustrated and described in detail in the foregoing description, such description is to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1: A glass cover for a near-infrared sensor operating in a wavelength range from 850 nm to 1550 nm, the glass cover having an internal face destined to face the near-infrared sensor and an external face opposite to the internal face and comprising:
a. at least a first glass sheet; and
b. a porous antireflective coating
i. deposited on the internal face and/or on the external face, and
ii. presenting a mean refractive index from 1.32 to 1.42 in the wavelength range from 850 nm to 1550 nm;
wherein the antireflective coating presents an optical thickness having a minimal value of:
$$0.208 λ + 2 nm$$
and a maximal value of:
$$0.303 λ + 11 nm$$
where λ is an operating wavelength in nm of the near-infrared sensor.

2: The glass cover according to claim 1, wherein the porous antireflective coating is applied on the internal face of the glass cover.

3: The glass cover according to claim 1, wherein the antireflective coating is based on a mineral composition for which a difference in gain in transmission and/or transmission loss, due to heat treatment at a temperature of at least 500° C. for a duration of at least 5 minutes is less than 1%.

4: The glass cover according to claim 1, wherein the near-infrared sensor is a lidar.

5: The glass cover according to claim 4, wherein the lidar is configured to emit a p-polarized beam according to an incident plane formed by a normal vector of the glass cover and a vector of an incident beam of the lidar, the beam being p-polarized at least at 60%.

6: The glass cover according to claim 1, wherein the glass cover further comprises a second glass sheet and an interlayer laminating the first glass sheet and the second glass sheet.

7: The glass cover according to claim 1, wherein the at least first glass sheet has an absorption coefficient less than 15 m⁻¹ at the operating wavelength of the near-infrared sensor.

8: The glass cover according to claim 1, wherein the glass cover is at least a part of a windshield, a backlite, a sidelite or an exterior trim element of a vehicle.

9: A system comprising: a glass cover according to claim 1.

10: The system according to claim 9, wherein the lidar is a p-polarized light beam emitting lidar, according to an incident plane formed by a normal vector of the glass cover and a vector of the incident beam of the lidar, wherein the light beam is p-polarized at least at 60%.

11: The system according to claim 9 wherein the lidar is configured so that the angle of incidence of the beam from the lidar on the glass cover is comprised between 0° and 65°, more preferably between 45° and 65° (measured from the normal to the glass cover).

12: The system according to claim 9, wherein the lidar has an operating wavelength of 905 nm or 1550 nm.

13: A vehicle comprising a system according to claim 9.

14: The glass cover according to claim 1, wherein the antireflective coating is based on a mineral composition for which a difference in gain in transmission and/or transmission loss, due to heat treatment at a temperature of at least 600° C. for a duration of at least 5 minutes is less than 1%.

15: The glass cover according to claim 1, wherein the antireflective coating is based on a mineral composition for which a difference in gain in transmission and/or transmission loss, due to heat treatment at a temperature of at least 500° C. for a duration of at least 5 minutes is less than 0.5%.

16: The glass cover according to claim 5, wherein the beam is being p-polarized at least at 80%.

17: The glass cover according to claim 1, wherein the at least first glass sheet has an absorption coefficient less than 10 m⁻¹ at the operating wavelength of the near-infrared sensor.

18: The glass cover according to claim 1, wherein the at least first glass sheet has an absorption coefficient less than 5 m⁻¹ at the operating wavelength of the near-infrared sensor.

19: The system according to claim 9, wherein the lidar is a p-polarized light beam emitting lidar, according to an incident plane formed by a normal vector of the glass cover and a vector of the incident beam of the lidar, wherein the light beam is p-polarized at least at 80%.
